(19) United States
(12) Patent Application Publication
(10) Pub. No.: US 2006/0240813 A1
(43) Pub. Date: Oct. 26, 2006

(54) Data communication system and method for determining round-trip-time adaptable to communication environment

(75) Inventor: Yong-Soo Baek, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/409,153

(22) Filed: Apr. 21, 2006

(30) Foreign Application Priority Data
Apr. 21, 2005 (KR) 2005-33211

(51) Int. Cl. H04Q 7/20

(52) U.S. Cl. 455/422.1

(57) ABSTRACT

A data communication system adapting a radio link protocol (RLP) includes at least one base transceiver station (BTS) for communicating with a plurality of subscriber stations (SSs); and a base station controller (BSC) for setting radio link protocol (RLP) round-trip-time (RTT) value for the at least one BTS under its control and transmitting each value to the at least one BTS, wherein the at least one BTS transmits its unique RTT value received from the BSC to the SS when handoff of the SS occurs.

### PRIORITY

This application claims priority under 35 U.S.C. §119 to an application entitled “Data Communication System and Method for Determining Round-Trip-Time Adaptable to Communication Environment” filed in the Korean Intellectual Property Office on Apr. 21, 2005 and assigned Ser. No. 2005-33211, the contents of which are incorporated herein by reference.

### BACKGROUND OF THE INVENTION

1. Field of the Invention

The present invention relates to a subscriber station for resetting a round-trip-time (RTT) value when handoff is performed in a mobile communication system adopting a radio link protocol (RLP) and a method thereof.

2. Description of the Related Art

In general, a Code Division Multiple Access (CDMA) mobile communication system has been developed from a voice-oriented IS-95 standard to a CDMA 2000 standard by which voice communication and high speed data communication are possible. According to the CDMA 2000 standard, various services such as high quality voice, audio/video (AV) and Internet surfing are possible.

The CDMA mobile communication systems corrects data loss occurring in a wireless environment using a radio link protocol (RLP) when data communication is performed. The RLP uses a negative acknowledgement (NAK) frame based on an Automatic Repeat Request (ARQ) scheme in order to correct an error generated in a wireless (i.e., air) channel. That is, if an RLP receiver detects that an RLP frame has not been received, the RLP receiver transmits a NAK frame requesting retransmission of the corresponding RLP frame, to an RLP transmitter. In response, the RLP transmitter which has received the request for retransmission, retransmits the requested RLP frame to the RLP receiver.

FIG. 1 is a schematic diagram illustrating a conventional data communication system.

Referring to FIG. 1, packet zones 1 and 2 (20 and 30, respectively) are zones having a predetermined range in which packet communication can be performed in the same environment. A unit of the packet zone can be different according to service providers or system types. Even in one type of system, a unit of the packet zone can be different according to system versions.

As shown in FIG. 1, a packet zone is commonly formed by gathering several base transceiver stations (BTSs). For example, the packet zone 1 20 includes BTS. 12, 14 and 16. More than one subscriber station (SS) 50 belonging to one packet zone performs packet communication in the same environment. Thus, even if the SS 50 moves between the BTSs 12, 14 and 16 belonging to the packet zone 1 20, no change occurs in the packet communication.

However, as handoff occurs if the SS 50 moves between BTSs while performing a voice call, if the SS 50 moves between packet zones while performing a packet communication, a packet communication initialization is performed.

For example, when the SS 50 moves from a coverage area 22 of a BTS 1 12 to a coverage area 26 of a BTS 2 16 in the same packet zone 1 20, the packet communication initialization is not performed while a handoff for a voice call occurs. However, when the SS 50 moves from the coverage area 26 of the BTS 2 16 in the packet zone 1 20 to a coverage area 32 of a BTS 4 60 in another packet zone 2 30, the SS 50 performs the packet communication initialization with the BTS 4 60.

FIG. 2 is a flow diagram illustrating a packet communication initialization between the SS 50 and the BTS 4 60.

Referring to FIG. 2, when the SS 50 sets up a data call to receive a high-speed data service or moves between packet zones, in step 80, the SS 50 performs an RLP initialization. In the RLP initialization of step 80, the SS 50 and the BTS 4 60 achieve the RLP initialization by matching RLP parameters to each other while sending/receiving RLP_BLOB (Block of Bits) message to/from each other. Herein, the BTS 4 60 transmits the RLP_BLOB in which an RTT estimation value is included to the SS 50. The RTT estimation value determined in an RLP session is used to determine transmission timing of a NAK frame. The RLP initialization for setting a timer is achieved when an initial call between the SS 50 and the BTS 4 60 is set. As described above, even when a call is set up and a service is proceeding, the RLP initialization can be reset. After the RLP initialization is finished, in step 82, the SS 50 and the BTS 4 60 perform point-to-point protocol (PPP) initialization for a data service. After the PPP initialization is finished, in step 84, data communication between the SS 50 and the BTS 4 60 is achieved.

As described above, when the SS 50 moves between packet zones while performing packet data communication, a relevant BTS requests the performing an initialization process SS 50 by, and then the SS 50 sets a new RTT value by performing RLP sync exchange procedures. The newly set RTT value is a reference to detect a missed frame of the SS 50. However, for a simple inter-BTS handoff, a target BTS does not request the resetting the RTT value SS 50 by, and thus the SS 50 cannot obtain an RTT value which is optimal for a new data communication environment and determines whether a missed frame is generated according to the RTT value set by a previous BTS.

Likewise, since the SS 50 determines whether a missed frame is generated using an RTT value set in a different communication environment, the SS 50 cannot accurately respond to a current communication environment. Thus, the SS 50 unnecessarily waits for a frame in a waiting state or requests an unnecessary and/or inadequate retransmission in a waiting state, which wastes time and system resources state where.

### SUMMARY OF THE INVENTION

Accordingly, the present invention provides a receive apparatus and method for adaptively determining in an actual communication environment a round-trip-time (RTT) value used to detect a missed frame in a mobile communication system adopting a radio link protocol (RLP).

According to one aspect of the present invention, there is provided a data communication system adopting a radio link protocol (RLP), the system including at least one base transceiver station (BTS) for communicating with a plurality of subscriber stations (SSs) and a base station controller (BSC) for setting the radio link protocol (RLP) and a round-trip-time (RTT) value for each of the plurality of BTSs under the BSC's control and transmitting corresponding RLP RTT values to BTS of the plurality BTSs, wherein the corresponding BTS transmits the corresponding RTT value received from the BSC to an SS of the plurality of SSs when a handoff of the SS occurs.

According to another aspect of the present invention, there is provided a method in a radio link protocol (RLP) data communication system including at least one base transceiver station (BTS) for communicating with subscriber stations (SSs) and a base station controller (BSC) for controlling the at least one BTS, the method including setting, by the BSC, a radio link protocol (RLP) round-trip-time (RTT) value for a corresponding BTS under the control of the BSC and transmitting the corresponding RLP RTT value to the at least one BTS, and transmitting, by the at least one BTS, the corresponding RLP RTT value received from the BSC to the SS when a handoff of a corresponding SS occurs.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic diagram illustrating a conventional data communication system;

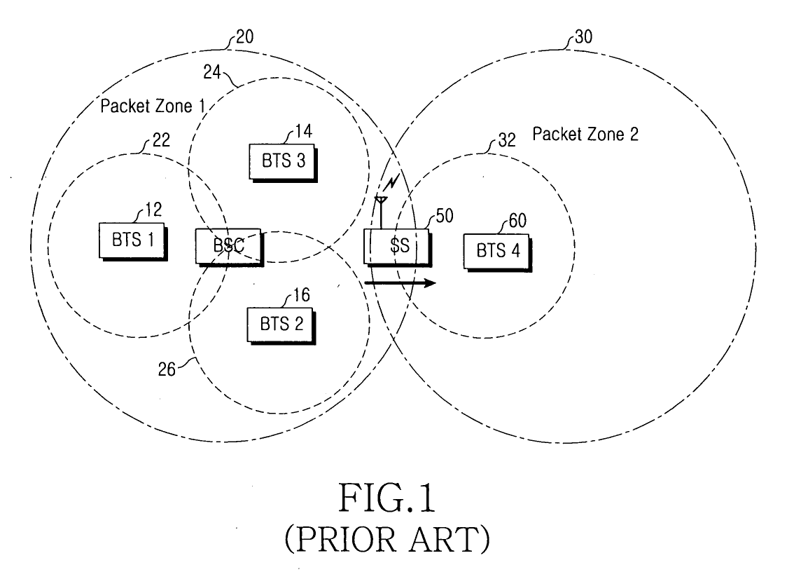

FIG. 2 is a flow diagram illustrating a packet communication initialization between an SS and a BTS;

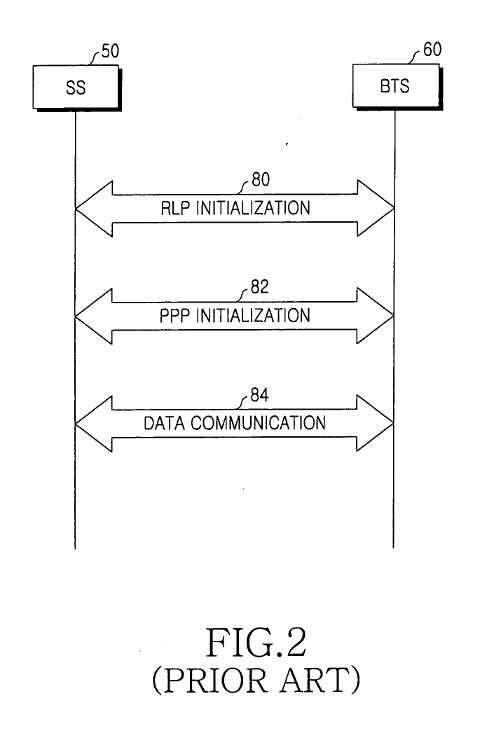

FIG. 3 is a schematic diagram illustrating a data communication system according to a preferred embodiment of the present invention;

FIG. 4 is a flow diagram illustrating a setting of RTT values in the data communication system according to a preferred embodiment of the present invention;

FIG. 5 is a flowchart illustrating an operation of a BSC according to a preferred embodiment of the present invention; and

FIG. 6 is a flowchart illustrating an operation of an SS according to a preferred embodiment of the present invention.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

In the present invention, a data communication system allows a BTS to transmit a new RTT value to an SS and makes an optimal communication environment. Accordingly, the present invention more closely realizes actual communication environments and uses a variable RTT value which is suitable for the communication environment.

This differs from the prior art communication systems which used a fixed round-trip-time (RTT) value which is used when a subscriber station (SS) moves between base transceiver stations (BTSs).

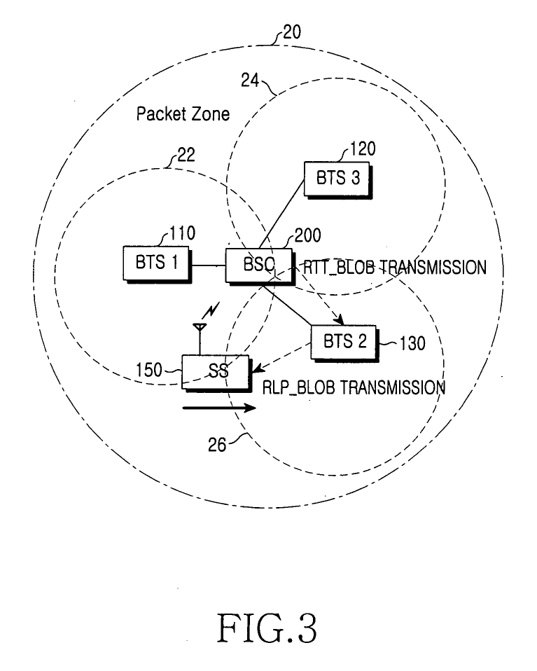

A data communication system according to a preferred embodiment of the present invention will now be described with reference to FIG. 3 which is a schematic diagram illustrating a preferred embodiment of the present invention.

As shown in FIG. 3, an SS 150 sets a radio link protocol (RLP) communication link for data communication with BTSs 110, 120 and 130. Before certain data is exchanged between the SS 150 and one of the BTSs 110, 120 and 130, an RLP link between the SS 150 and a corresponding one of the BTSs 110, 120 and 130, should be set. The RLP link setting includes setting of an RTT used by the SS 150 and one of the BTSs 110, 120 and 130 for NAK timing.

Referring to FIG. 3, when the SS 150 moves between BTSs (e.g., from a BTS 1 110 to a BTS 2 130) while performing a packet data communication, the data communication is continuously maintained without cut-off or re-initialization unless a packet zone is changed. Herein, when inter-BTS handoff occurs, it is assumed that communication environments can substantially vary due to regional changes and communication path changes. In this case, it is unnecessary to perform an initialization process again from the previous initialization due to the movement of the SS 150 between BTSs, and it is only necessary for the BTS 2 130 to download a new RTT value to the SS 150 through an RLP_BLOB (Block of Bits) message.

However, according to the prior art as applied to FIG. 3, each of the BTSs 110, 120, and 130 does not have a unique RTT value. In contrast, in the present embodiment of the present invention, each BTS is configured to have a unique RTT value. In detail, a base station controller (BSC) 200 sets RTT values of the BTSs 110, 120, and 130. The BSC 200 provides unique RTT values to the BTSs 110, 120 and 130 using a newly defined signaling called RTT_BLOB message.

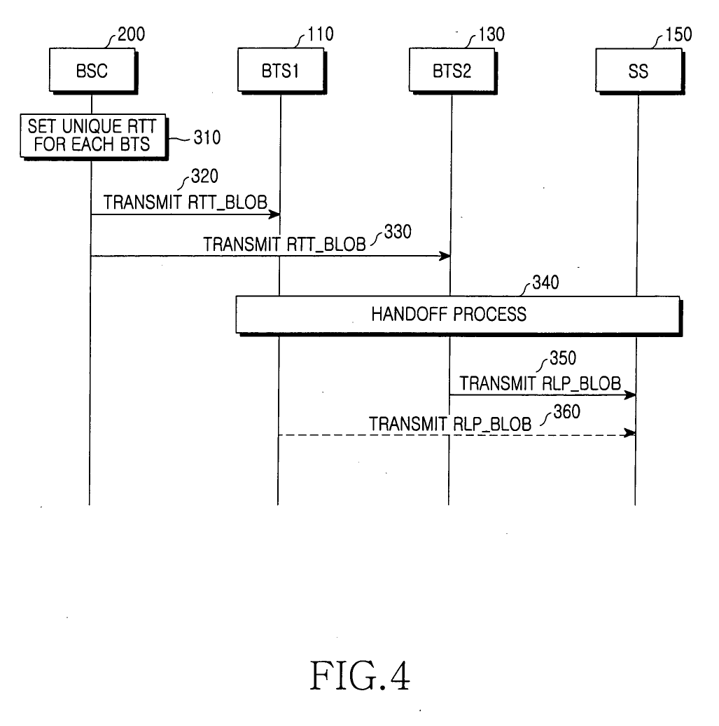

FIG. 4 is a flow diagram illustrating a setting of RTT values in the data communication system according to a preferred embodiment of the present invention. In FIG. 4, only two BTSs are shown for sake of clarity.

Referring to FIGS. 3 and 4, the BSC 200 determines unique RTT values for the BTSs 110 and 130 and transmits n RTT_BLOB including each RTT value to each of the BTSs 110 and 130. In detail, in step 310, the BSC 200 generates RTT values unique to the BTSs 110 and 130. The BSC 200 should maintain RTT values of the BTSs 110 and 130 under its control and should periodically update the RTT values in order to transmit the RTT values unique to the BTSs 110 and 130. The unique RTT values for the BTSs 110 and 130 are determined by considering factors such as packet load balancing and round-trip-delay for the BTSs 110 and 130. Since the packet load balancing and round-trip-delay are well known in the art, a detailed description is omitted.

In steps 320 and 330, the BSC 200 transmits each RTT_BLOB in which each corresponding RTT value unique to each of the BTSs 110 and 130 is included to each of the BTSs 110 and 130. Each RTT_BLOB includes an RTT_BLOB_TYPE field for indicating an RTT_BLOB TYPE), an RLP_VERSION field for indicating a currently used RLP version, an RTT field for indicating an RTT value to be set and an INIT_VAR field for indicating an initialization of an RTT value which a corresponding BTS possesses. An exemplary RTT_BLOB message is illustrated in Table 1.

TABLE 1

| | Length | |
|---|---|---|
| Field | (bits) | Description |
| RTT_BLOB_TYPE | 3 | The type of RTT_BLOB structure. |
| | | Set to ‘001’ |
| RLP_VERSION | 3 | The version of RLP being used |
| RTT | 4 | The value of RTT to be set in BTS |
| INIT_VAR | 1 | Set to ‘1’ to force RTT |
| | | to ‘0’ in BTS; or |
| | | Set to ‘0’ to set a new |
| | | RTT value to BTS |

The RTT_BLOB message shown in Table 1 is an exemplary embodiment, and it will be understood by those skilled in the art that various changes may be made therein. The RTT values are periodically updated by the BSC 200, and the BTSs 110 and 130 store the RTT values received from the BSC 200, respectively. With reference to FIGS. 3 and 4, in step 340, the SS 150 performs a handoff between the BSC1 110 and the BTS2 130. In step 350 or 360, a BTS to which the SS 150 belongs among the BTSs 110 and 130, i.e., a handoff target BTS 110 or 130, transmits RLP_BLOB message including its unique RTT value to the SS 150. That is, an RTT field of the RLP_BLOB has the unique RTT value determined by the BSC 200. The RLP_BLOB message is originally used in an RLP initialization performed when the SS 150 moves between packet zones, and in this case, the RTT field is fully occupied with zeros.

That is, when inter-BTS handoff occurs, the BTS 110 or 130 transmits its unique RTT value to the SS 150 so that the SS 150 can perform packet data communication in an optimal communication environment.

When the SS 150 receives the RLP_BLOB message from the BTS 110 or 130, the SS 150 determines whether the RLP_BLOB message is transmitted due to a packet initialization or handoff. If the RTT field is occupied with non-zeros, the SS 150 immediately sets the RTT value without performing unnecessary RLP sync exchange procedures with the BTS 110 or 130. Alternatively, if the RTT field is occupied with zeros, the SS 150 determines an RTT value of the SS 150 through calculation by performing the RLP sync exchange procedures. The RLP_BLOB message is not used when the SS 150 simply moves between BTSs but is used for a BTS to provide an RTT value to the SS 150 when handoff is performed.

Control flows in the BSC 200 and SS 150 will now be described.

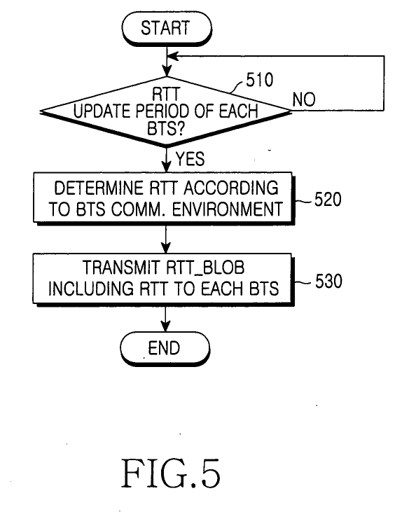

FIG. 5 is a flowchart illustrating an operation of the BSC 200 according to a preferred embodiment of the present invention. Referring to FIG. 5, in step 510, the BSC 200 determines whether an RTT value update period of the BTSs 110, 120 and 130 has arrived. The BSC 200 should maintain RTT values of all the BTSs 110, 120 and 130 under its control and should periodically update the RTT values in order to transmit the RTT values unique to the BTSs 110, 120 and 130. If it is determined that the RTT value update period has arrived in step 510, step 520 is performed. In step 520, the BSC 200 determines each RTT value according to each BTS communication environment. Each RTT value is determined as a unique value for each BTS considering packet load balancing and round-trip-delay. In step 530, the BSC 200 inserts each determined RTT value into an RTT_BLOB message and transmits the RTT_BLOB message to each of the BTSs 110, 120 and 130. As described above, each RTT_BLOB message includes an RTT_BLOB_TYPE field, an RLP_VERSION field, an RTT field and an INIT_VAR field.

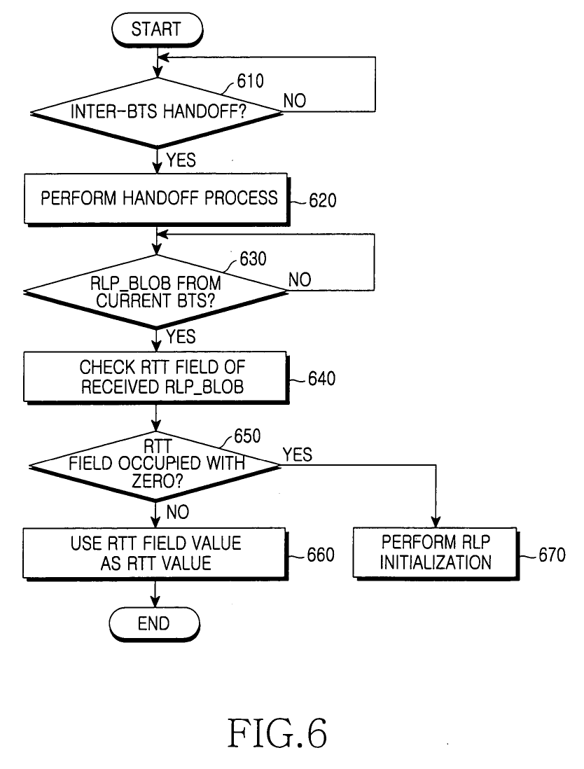

FIG. 6 is a flowchart illustrating an operation of the SS 150 according to a preferred embodiment of the present invention. Referring to FIG. 6, in step 610, the SS 150 determines whether inter-BTS handoff occurs. If the inter-BTS handoff occurs, in step 620, the SS 150 performs a handoff process. In step 630, the SS 150 checks whether RLP_BLOB message is received from a BTS to which the SS 150 currently belongs. If the SS 150 moves to a coverage area of the BTS, the BTS transmits the RLP_BLOB message including its unique RTT value to the SS 150. If the SS 150 receives the RLP_BLOB from the BTS, the SS 150 determines whether the RTT field in RLP_BLOB message is occupied with zero or not. Usually, the BTS transmits its unique RTT value, not zero. If the RTT value is zero, the SS 150 does not use the RTT value, but calculates an RTT value suitable for a wireless environment by performing the RLP initialization procedure. To do this, in step 640, the SS 150 checks an RTT field of the received RLP_BLOB message. In step 650, the SS 150 determines whether the RTT field of the RLP_BLOB is occupied with zeros. If the RTT field of the RLP_BLOB message is occupied with non-zero, in step 660, the SS 150 immediately sets the RTT value without performing unnecessary RLP sync exchange procedures with the BTS. Alternatively, if the RTT field is occupied with zeros, in step 670, the SS 150 determines an RTT value of the SS 150 through calculation by performing the RLP sync exchange procedures.

As described above, according to embodiments of the present invention, by using an optimal RTT value for each BTS and re-transmitting the RTT value when inter-BTS handoff occurs, a data communication speed and accuracy are enhanced, thereby allowing faster downloading of data. Moreover, costs can be reduced. Furthermore, since an SS occupies a channel for shorter periods of time, system capacity is increased and services can be provided to more subscribers.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A data communication system adapting a radio link protocol (RLP), the system comprising:
at least one base transceiver station (BTS) for communicating with a plurality of subscriber stations (SSs); and
a base station controller (BSC) for setting a radio link protocol (RLP) round-trip-time (RTT) value corresponding to the at least one BTS under the BSC's control and transmitting the RTT value to the at least one BTS,
wherein the at least one BTS transmits the corresponding RTT value received from the BSC to an SS of the plurality of SSs when a handoff of the SS occurs.

2. The system of claim 1, wherein the BSC inserts the RTT value into RTT_BLOB (Block of Bits) message and transmits the RTT_BLOB message to the BTS.

3. The system of claim 1, wherein the BTS inserts the corresponding RTT value into RLP_BLOB message and transmits the RLP_BLOB message to the SS.

4. The system of claim 2, wherein the RTT_BLOB message includes an RTT field for indicating the set RTT value and further includes at least one of an RTT_BLOB_TYPE field for indicating an RTT_BLOB type, an RLP_VERSION field for indicating a currently used RLP version and an INIT_VAR field for indicating an initialization of an RTT value which a corresponding BTS possesses.

5. The system of claim 4, wherein when the SS receives the RLP_BLOB message, the SS checks an RTT field of the RLP_BLOB message, and sets the RTT value without performing RLP sync exchange procedures, if the RTT field is occupied with non-zero.

6. The system of claim 4, wherein when the SS receives the RLP_BLOB message;
checks an RTT field of the RLP_BLOB message; and
sets a corresponding RTT value through calculation by performing the RLP sync exchange procedures if the RTT field is occupied with at least one zero.

7. The system of claim 1, wherein the BSC periodically updates the RTT value corresponding to each BTS.

8. The system of claim 1, wherein the BSC considers at least one of packet load balancing and round-trip-delay in order to set the RTT value.

9. A method in a radio link protocol (RLP) data communication system including at least one base transceiver station (BTS) for communicating with a plurality of subscriber stations (SSs) and a base station controller (BSC) for controlling the at least one BTS, the method comprising the steps of:
setting, by the BSC, each radio link protocol (RLP) round-trip-time (RTT) value for the at least one BTS under the control of the BSC and transmitting each RTT value to each of the at least one BTS; and
transmitting, by the at least one BTS, a corresponding RTT value received from the BSC to an SS of the plurality of SSs when handoff of the SS occurs.

10. The method of claim 9, further comprising
inserting, by the BSC, the RTT value corresponding to the BTs into an RTT_BLOB (Block of Bits) message.

11. The method of claim 9, further comprising
inserting, by the BTS, the RTT value corresponding to the BTS into RLP_BLOB (Block of Bits) message.

12. The method of claim 10, wherein the RTT_BLOB message includes an RTT field indicating the RTT value corresponding to the BTs and further includes at least one of an RTT_BLOB_TYPE field for indicating an RTT_BLOB type, an RLP_VERSION field for indicating a currently used RLP version and an INIT_VAR field for indicating initialization of an RTT value which a corresponding BTS possesses.

13. The method of claim 11, further comprising the steps of:
checking an RTT field of the RLP_BLOB message, if the SS receives the RLP_BLOB message; and
setting the RTT value without performing RLP sync exchange procedures, if the RTT field is occupied with non-zeros.

14. The method of claim 11, further comprising the steps of:
checking an RTT field of the RLP_BLOB message, if the SS receives the RLP_BLOB message; and
if the RTT field is occupied with zeros, setting an RTT value through calculation by performing the RLP sync exchange procedures.

15. The method of claim 9, further comprising:
periodically updating, by the BSC, the RTT value of each BTS.

16. The method of claim 9, further comprising:
setting, by the BSC, the RTT value by considering at least one of a packet load balancing and a round-trip-delay.
